(19) United States
(12) Patent Application Publication
(10) Pub. No.: US 2013/0159877 A1
(43) Pub. Date: Jun. 20, 2013

(54) STEALTH MODE FOR INTERACTING WITH ELECTRONIC MESSAGES

(71) Applicants: Edward Thomas Banti, Seattle, WA (US); Selvaraj Nalliah, Redmond, WA (US)

(72) Inventors: Edward Thomas Banti, Seattle, WA (US); Selvaraj Nalliah, Redmond, WA (US)

(73) Assignee: MICROSOFT CORPORATION, Redmond, WA (US)

(21) Appl. No.: 13/330,053

(22) Filed: Dec. 19, 2011

(51) Int. Cl. G06F 3/01; G06F 15/16

(52) U.S. Cl. 715/752

(57) ABSTRACT

A stealth mode may be used to interact with electronic messages. A user may enter the stealth mode to interact with electronic messages without making state changes to the messages. While operating in stealth mode, operations (e.g. implicit operations such as reading a message) do not change the state of the electronic messages. Upon exiting the stealth mode, the state of the electronic messages is the same as before entering the stealth mode. According to an embodiment, explicit operations performed during stealth mode (e.g. marking a message as “read”, deleting/forwarding/replying a message, . . . ) may change the state of the message relating to the action.

### BACKGROUND

Users commonly view electronic messages and perform other operations on electronic messages (e.g. forwarding, replying, marking urgent, moving . . . ). When a user views an electronic message (or performs other operations), the display of the electronic message often changes. For example, before an electronic message is read by the user it is shown in an unread state. After reading the message, the electronic message is displayed in a read state. When a user wants to return the electronic message to the unread state from the read state, the user manually selects an option to undo the read operation that was performed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A stealth mode may be used to interact with electronic messages. A user may enter the stealth mode to interact with electronic messages without making state changes to the messages. While operating in stealth mode, operations (e.g. implicit operations such as reading a message) do not change the state of the electronic messages. Upon exiting the stealth mode, the state of the electronic messages is the same as before entering the stealth mode. According to an embodiment, explicit operations performed during stealth mode (e.g. marking a message as “read”, deleting/forwarding/replying a message, . . . ) may change the state of the message relating to the action. For example, a user may enter the stealth mode, read different electronic messages, specifically mark one message as “read”, and then exit the stealth mode. After exiting the stealth mode, the electronic messages that are read, but not specifically marked as “read” are still in the “unread” state and are shown in the display as “unread”.

### BRIEF DESCRIPTION OF THE DRAWINGS

FIG. 1 illustrates an exemplary computing device;

FIG. 2 illustrates an exemplary system for interacting with messages using a stealth mode;

FIG. 3 shows a display illustrating a messaging window that shows a user interacting with electronic messages in a stealth mode;

FIG. 4 shows an illustrative process for interacting with electronic messages using a stealth mode;

FIG. 5 illustrates a system architecture used in interacting with electronic messages; and

FIGS. 6-7 show exemplary displays illustrating stealth mode interaction.

### DETAILED DESCRIPTION

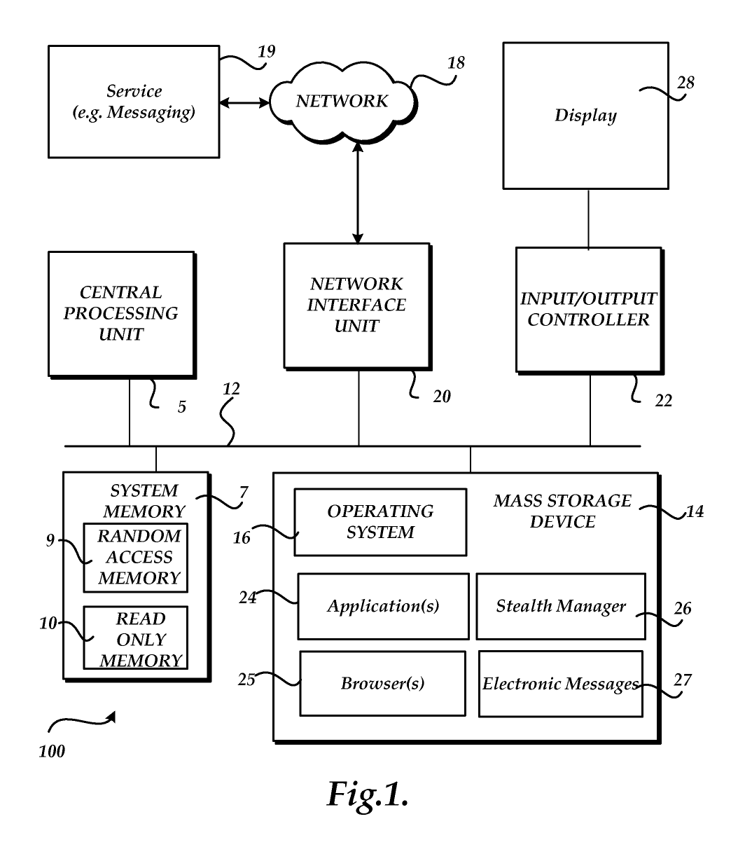

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server computing device, a desktop computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, electronic messages 27, and other program modules, such as Web browser 25, and stealth manager 26, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, may be integrated with other components of the computer 100 on the single integrated circuit (chip).

As mentioned briefly above, a number of program modules and data files may be stored in the mass storage device 14 and RAM 9 of the computer 100, including an operating system 16 suitable for controlling the operation of a networked computer, such as the WINDOWS 7®, WINDOWS SERVER® operating systems from MICROSOFT CORPORATION of Redmond, Wash.

The mass storage device 14 and RAM 9 may also store one or more program modules. In particular, the mass storage device 14 and the RAM 9 may store one or more applications, such as stealth manager 26, messaging applications 24 (e.g. a messaging application such as MICROSOFT OUTLOOK, an Instant Messaging (IM) application, an SMS message, and the like), and may store one or more Web browsers 25. The Web browser 25 is operative to request, receive, render, and provide interactivity with electronic content, such as Web pages, electronic messages, videos, documents, and the like. According to an embodiment, the Web browser comprises the INTERNET EXPLORER Web browser application program from MICROSOFT CORPORATION.

Stealth manager 26 may be located on a client device and/or on a server device (e.g. within service 19). Stealth manager 26 may be configured as an application/process and/or as part of a cloud based multi-tenant service that provides resources (e.g. services, data . . . ) to different tenants (e.g. MICROSOFT OFFICE 365).

Generally, stealth manager 26 is configured to perform operations relating to using a stealth mode for interacting with electronic messages. A user may enter the stealth mode to interact with electronic messages without making state changes to the messages. While operating in stealth mode, operations (e.g. implicit operations such as reading a message) do not change the state of the electronic messages. Upon exiting the stealth mode, the state of the electronic messages is the same as before entering the stealth mode. According to an embodiment, explicit operations performed during stealth mode (e.g. marking a message as “read”, deleting/forwarding/replying a message, . . . ) may change the state of the message relating to the action. For example, a user may enter the stealth mode, read different electronic messages, specifically mark one message as “read”, and then exit the stealth mode. After exiting the stealth mode, the electronic messages that are read, but not specifically marked as “read” are still in the “unread” state and are shown in the display as “unread”. Additional details regarding the operation of stealth manager 26 will be provided below.

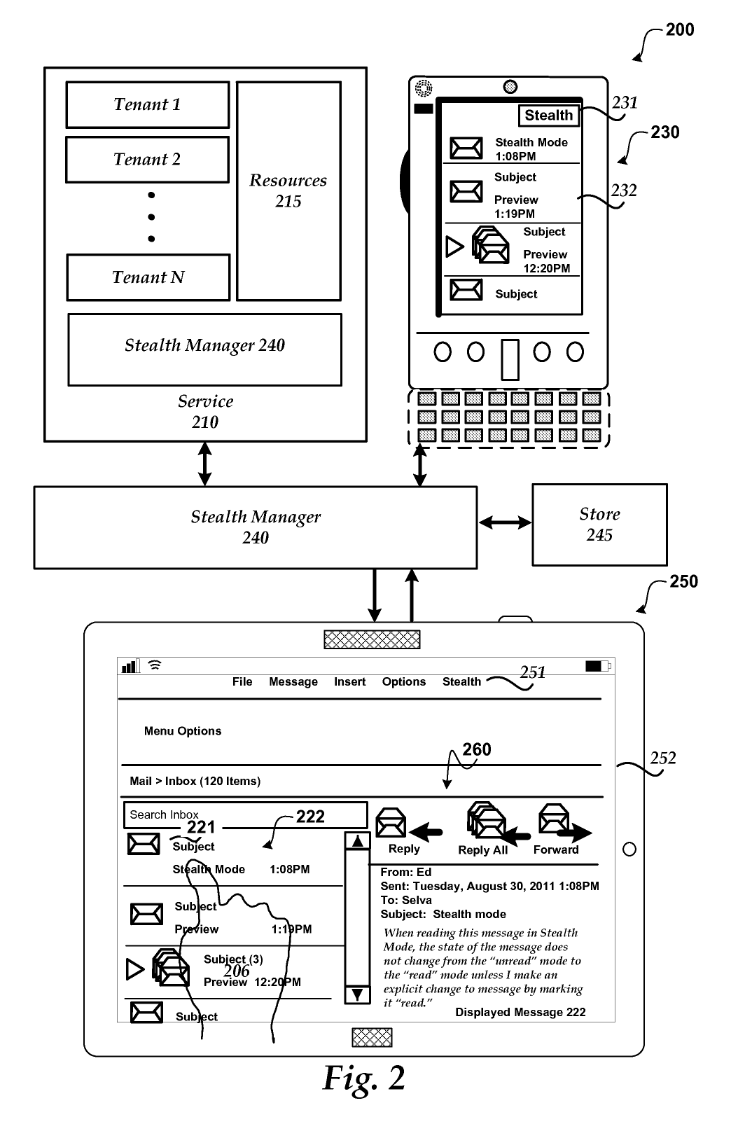

FIG. 2 illustrates an exemplary system for interacting with messages using a stealth mode. As illustrated, system 200 includes service 210, stealth manager 240, store 245, touch screen input device/display 250 (e.g. slate) and smart phone 230.

As illustrated, service 210 is a cloud based and/or enterprise based service that may be configured to provide electronic messaging services (e.g. MICROSOFT OFFICE 365 or some other cloud based/online service that provides messaging services). Functionality of one or more of the services/applications provided by service 210 may also be configured as a client based application. For example, a client device may include an application that performs operations relating to sending/receiving/interacting with electronic messages such as email messages. The messaging application/service may also provide messaging services relating to other types of messages (e.g. IM messages, SMS, MMS, and the like) Although system 200 shows a messaging service, other services/applications may be configured to use a stealth mode to interact with electronic messages.

As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 as illustrated comprises a touch screen input device/display 250 (e.g. a slate/tablet device) and mobile phone 230 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 250 and mobile device 230 shows an exemplary display 252/232 of electronic messages. Electronic messages may be stored on a device (e.g. mobile phone 230, slate 250 and/or at some other location (e.g. network store 245). Mobile phone 230 shows display 232 illustrating email messages shown in a list view. The electronic messages may be displayed by an email program, a text messaging program, an Instant Messaging program, a messaging service, and the like. The messages may be displayed in a list, arranged as threads, and/or arranged in different manners. The messages may be displayed by a client based application and/or by a server based application (e.g. enterprise, cloud based).

Stealth manager 240 is configured to perform operations relating to interacting with electronic messages using a stealth mode. The stealth mode may be entered by selecting a user interface option (e.g. option 231, menu item 251, and the like). Generally, while the stealth mode is active, interactions with the messages do not result in a state change to the messages. According to an embodiment, any actions that automatically occur that change a state of a message are suppressed during stealth mode. For example, client side rules are not performed while in stealth mode unless explicitly selected to be run.

As illustrated, a user 206 selects message 222 for viewing while in stealth mode. The operations, however, may be any of the operations that are supported by the electronic messaging application. For example, selecting a message to read, reply, reply all, forward, new email, change folders, move, new folder, navigate to next/previous message, sort messages, tag messages, and the like.

In response to selecting the message, the selected message is displayed within area 260. The message may be displayed other ways (e.g. in a separate window, a different portion of a window, and the like). For example, when a message is selected on mobile device 230, the display of the messages may be replaced by a display of the selected message.

The operation requested by the user to be performed may be an explicit operation (e.g. reply, reply all, forward, mark as read/urgent, tag, manually select one or more rules to run, delete, . . . ) or an implicit operation (e.g. read, navigate to another message/folder, sort messages, . . . ). Implicit operations and explicit operations may be treated differently when in stealth mode. According to an embodiment, when an operation is an implicit operation the state of the message is maintained when in stealth mode and when the operation is an explicit operation, the state of the message changes when not in stealth mode. According to another embodiment, when an operation is either an implicit operation or an explicit operation, the state of the message is maintained.

In the current example, it can be seen that even though the user is reading message 222, the email indicator 221 showing that the message has been read is not changed. The state of the message remains “unread” while in stealth mode even though the user is able to read the displayed message.

If the requested operation is an explicit operation, then a corresponding state for that operation may be changed that is associated with the message. For example, if a user marks the message as “read” then the read state of the message changes and correspondingly the email indicator would change to show the message as being read. When a user performs an explicit operation, the operation is performed (e.g. forwarding a message). According to an embodiment, only the operation explicitly requested allows a state to change. For example, forwarding a message would not change the “unread” state of the message to a “read” state. Instead, the forward state would change for the message.

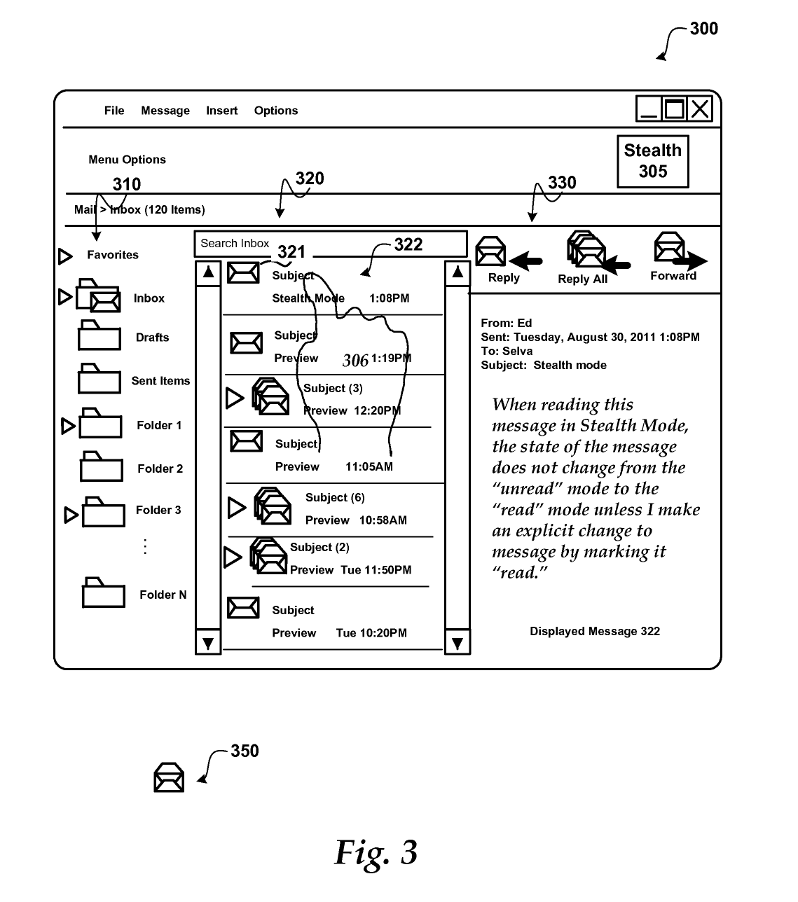

FIG. 3 shows a display illustrating a messaging window that shows a user interacting with electronic messages in a stealth mode. As illustrated, window 300 includes a folder list 310, a message list 320 and a preview area 330. More or fewer areas may be included within window 300. Window 300 may be a window that is associated with a desktop application, a mobile application and/or a web-based application (e.g. displayed by a browser). For example, a web browser may access an electronic mail service, an email application on a computing device may be configured to compose/send/receive emails from one or more different services, and the like.

A stealth option (e.g. stealth option 305) is used to enter/exit the stealth mode. In response to selecting/deselecting the stealth option the stealth option is entered/exited.

Folder list 310 shows different folders that may be selected to populate message list 320. For example, the Inbox folder may be selected to show the messages currently in the user's inbox. When a folder contains additional folders, an arrow indicator is displayed that may be used to expand/compress the display of the folders.

Message list 320 shows the messages that are contained within the selected folder from folder list 310. The messages illustrated within message list may be arranged in different manners. For example, the messages may be arranged by date, thread, sender, size, subject, attachments, importance, to:, categories, type, flag(s), and the like. As illustrated, the messages in message list 320 are displayed by date and conversation. Message list 320 shows single messages and message threads. The messages in message thread may be expanded by selecting the expand/collapse icon before the message thread.

Preview area 330 shows message content that is associated with a selected message/message thread. In the current example, a user 306 has selected message 322 using a touch input. Other input methods may be used (e.g. mouse input, stylus, voice input, keyboard input and/or other input methods). A graphical indicator, such as an icon and/or coloring/highlighting, may be displayed to indicate a selected message. According to an embodiment, the graphical indicator is shown when a user has not selected stealth mode. As illustrated, preview area 330 shows displayed message 322. Preview area also shows different options (e.g. Reply, Reply All, Forward).

As can be seen in the current example, even though the user is viewing message 322, the indicator 321 showing the message state (e.g. unread/read) does not change (e.g. to indicator 350) in response to reading the message during stealth mode.

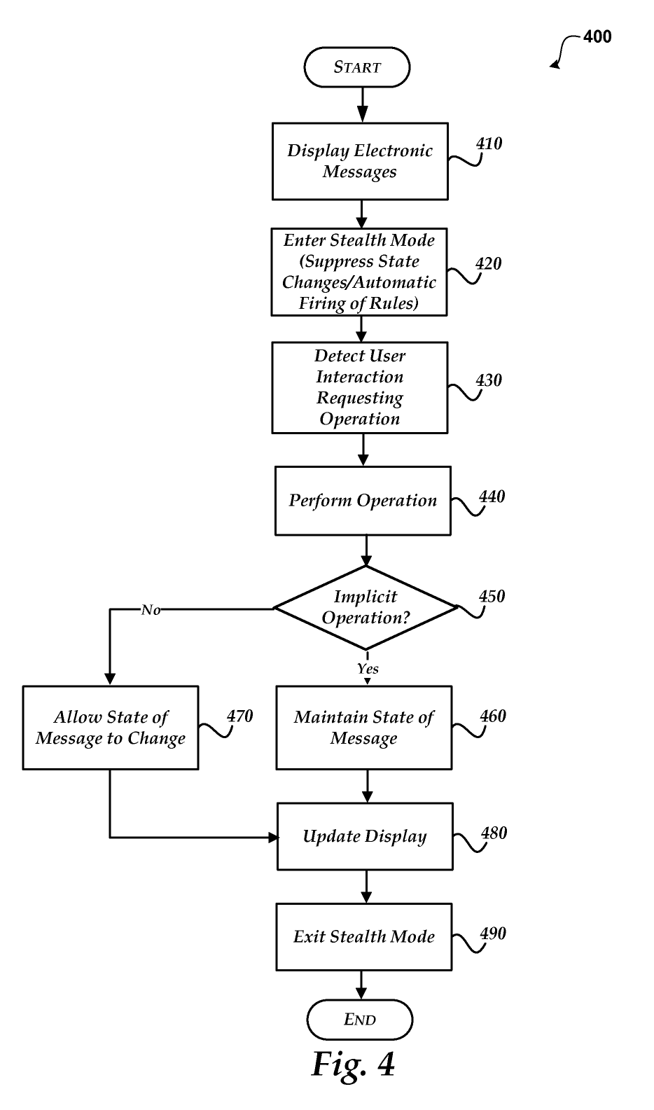

FIG. 4 shows an illustrative process for interacting with electronic messages using a stealth mode. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof While the operations are shown in a particular order, the ordering of the operations may change and be performed in other orderings.

After a start operation, the process flows to operation 410, where electronic messages are displayed. The electronic messages may be displayed using many different methods and applications. For example, the messages may be displayed by an email program, a text messaging program, an Instant Messaging program, and the like. The messages may be displayed in a list, arranged as threads, and/or arranged in different manners. The messages may be displayed by a client based application and/or by a server based application (e.g. enterprise, cloud based). According to an embodiment, the messages are email messages.

Moving to operation 420, a stealth mode is entered. The stealth mode may be entered by selecting a user interface option (e.g. menu, button, keystroke, gesture, and the like). Generally, while stealth mode is active, interactions with the messages do not result in a state change to the messages. According to an embodiment, any actions that automatically occur that change a state of a message are suppressed during stealth mode. For example, client side rules are not performed while in stealth mode unless explicitly selected.

Flowing to operation 430, a user interaction is detected that requests an operation to be performed relating to one or more of the messages. The operations may be any of the operations that are supported by the electronic messaging application. For example, selecting a message to read, reply, reply all, forward, new email, change folders, move, new folder, navigate to next/previous message, sort messages, tag messages, and the like.

Transitioning to operation 440, the operation is performed. For example, a selected message may be displayed within a preview area, may be displayed in a separate window, a different portion of a window, and the like. The operation performed may be an explicit operation (e.g. reply, reply all, forward, mark as read/urgent, tag, manually select one or more rules to run, delete, . . . ) or an implicit operation (e.g. read, navigate to another message, folder, sort . . . ).

Moving to decision operation 450, a determination is made as to whether an operation is an implicit operation. When the operation is an implicit operation the process flows to operation 460. When the operation is not an implicit operation (e.g. an explicit operation) the process flows to operation 470. According to an embodiment, when an operation is an implicit operation the state of the message is maintained and when the operation is an explicit operation, the state of the message changes when in the stealth mode. According to another embodiment, when an operation is either an implicit operation or an explicit operation, the state of the message is maintained.

At operation 460, the state of the message relating to the operation is maintained as it was before the operation was performed. For example, when a message is selected for viewing, the state of the message remains “unread” even though the user is able to read the displayed message.

At operation 470, the state of the message relating to the operation is changed when the operation is an explicit operation. For example, if a user marks the message as “read” then the read state of the message changes. When a user performs an explicit operation, the operation is performed (e.g. forwarding a message). According to an embodiment, only the operation explicitly requested allows a state to change. For example, forwarding a message would not change the “unread” state of the message to a “read” state.

Transitioning to operation 480, the display is updated in response to the operation being performed. For example, selecting a message to read shows a view of the selected message. According to an embodiment, any UI indicators to show the state of the message (e.g. read, unread) are not changed on the display.

Moving to operation 490, the stealth mode is exited upon de-selection of the stealth mode. The stealth mode may also be exited automatically (e.g. upon closing the messaging application) such that when the messaging application is opened it is not in the stealth mode.

The process then moves to an end operation and returns to processing other actions.

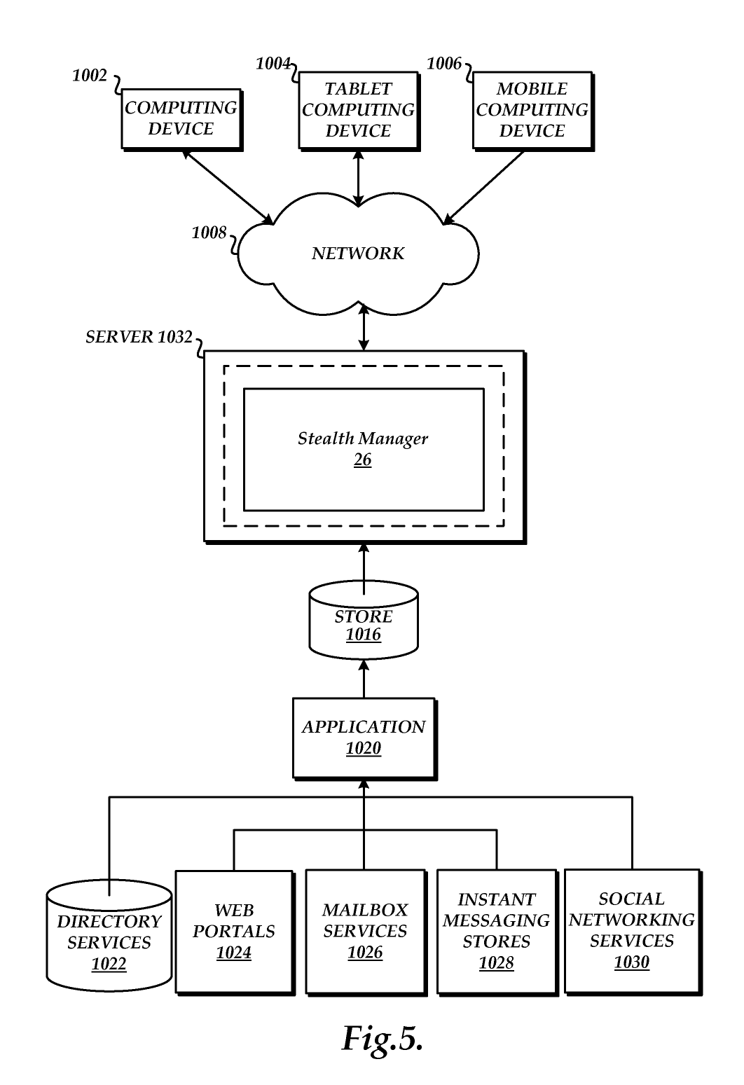

FIG. 5 illustrates a system architecture used in interacting with electronic messages, as described herein. Content used and displayed by the application (e.g. application 1020) and the stealth manager 26 may be stored at different locations. For example, application 1020 may use/store data using directory services 1022, web portals 1024, mailbox services 1026, instant messaging stores 1028 and social networking sites 1030. The application 1020 may use any of these types of systems or the like. A server 1032 may be used to access sources and to prepare and display electronic messages. For example, server 1032 may access electronic messages for application 1020 to display at a client (e.g. a browser or some other window). As one example, server 1032 may be a web server configured to provide messaging services (e.g. email, text messages, IM messages, and the like) to one or more users. Server 1032 may use the web to interact with clients through a network 1008. Server 1032 may also comprise an application program (e.g. a messaging application). Examples of clients that may interact with server 1032 and a presentation application include computing device 1002, which may include any general purpose personal computer, a tablet computing device 1004 and/or mobile computing device 1006 which may include smart phones. Any of these devices may obtain content from the store 1016.

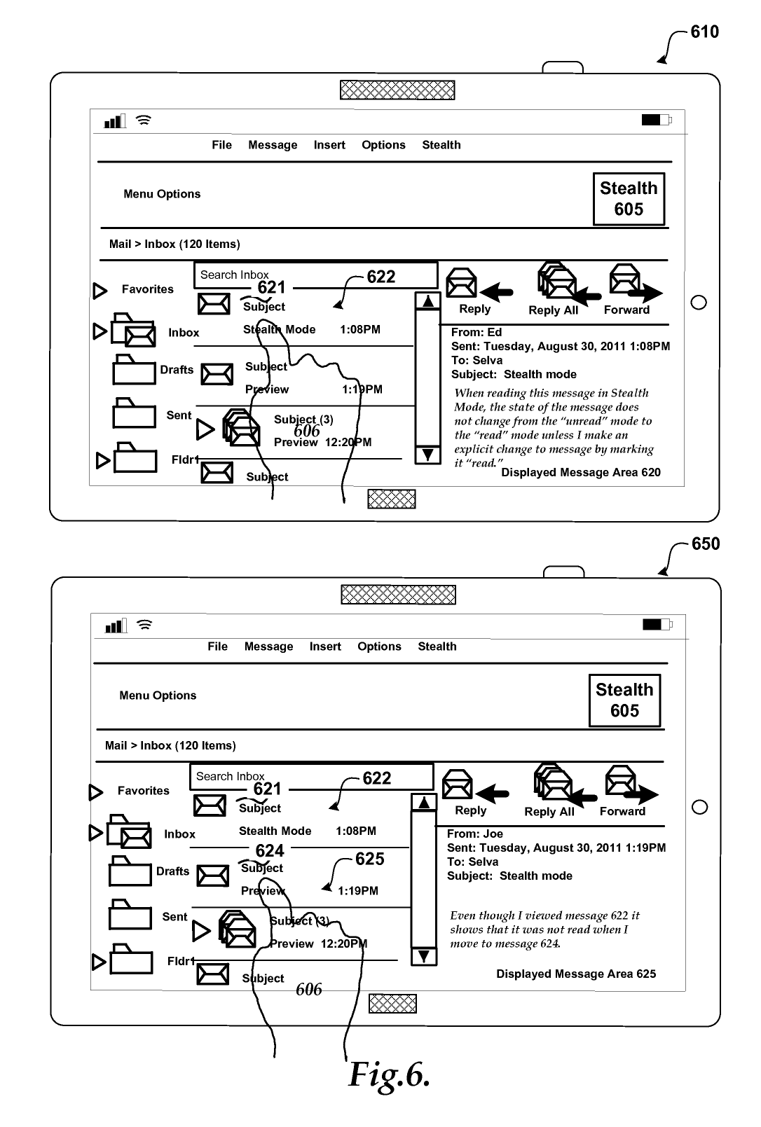

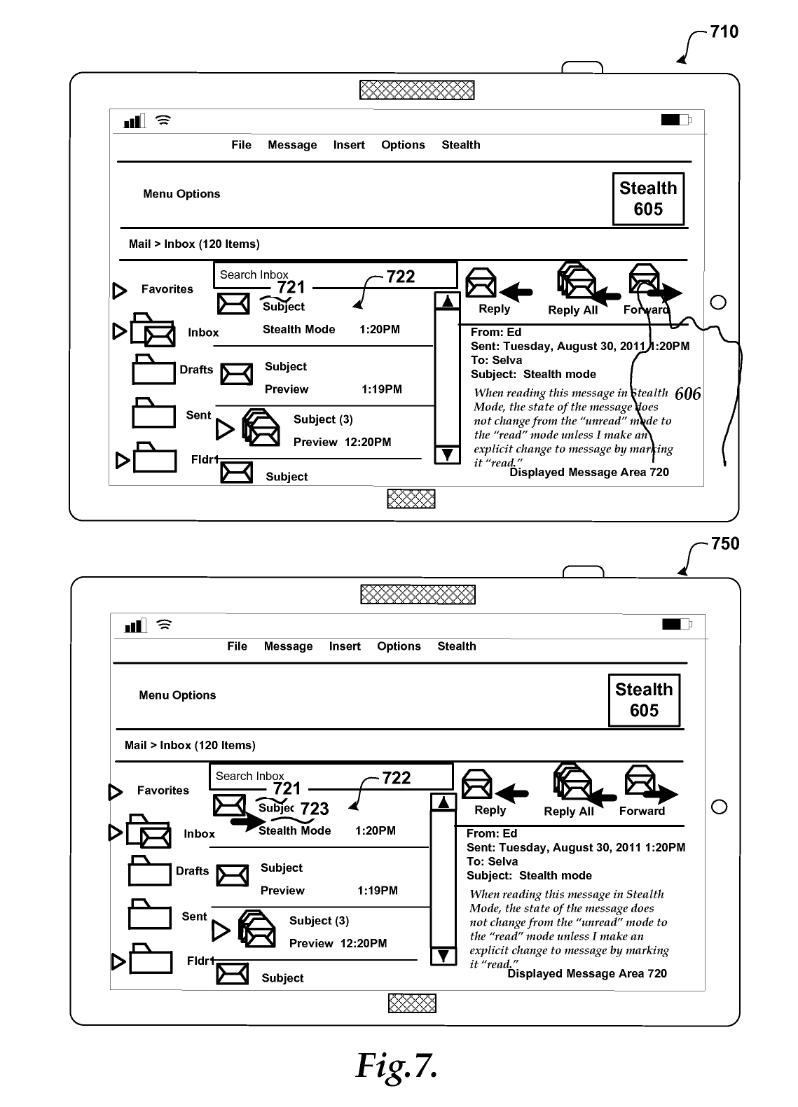

FIGS. 6-7—show exemplary displays illustrating stealth mode interaction. The examples shown herein are for illustration purposes and not intended to be limiting.

FIG. 6 shows an exemplary landscape slate display showing interaction with electronic messages while in stealth mode.

Display 610 shows a user selecting a message (622) while in stealth mode. In response to selecting the message, the message is displayed, such as in displayed message area 620. Selecting message 622 in stealth mode does not change the state (e.g. read state) of the message.

Display 650 shows the user selecting message 624 to view. In response to selecting the message, the message is displayed in displayed message area 625. As can be seen, even though the user previously viewed message 622, the email read indicator 621 remains in an unread state. Similarly, email indicator 624 remains in an unread state.

FIG. 7 shows an exemplary landscape slate display showing an explicit interaction with an electronic message while in stealth mode.

Display 710 shows a user 606 selecting a message (722) while in stealth mode to forward (an explicit action). In response to selecting the message to be forwarded, the message is forwarded.

Display 750 shows the view of message 722 after the message is forwarded. As can be seen, even though the user previously viewed message 722, the email read indicator 721 remains in an unread state. A forward indicator 723 has been added in response to the explicit action performed on message 722 while in stealth mode. In contrast to when operating in stealth mode, if the user were to view the message and forward the message when outside of the stealth mode, the email indicator would change to a read state (e.g. an open envelope) and the arrow would be displayed to show the forwarding.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for interacting with electronic messages, comprising:
displaying electronic messages;
detecting a user interaction requesting an operation to be performed on an electronic message;
performing the operation on the electronic message that attempts to change a state related to the electronic message;
maintaining the state related to the electronic message during interaction with the electronic message while in a stealth mode;
changing the state related to the electronic message during interaction with the electronic message when outside of the stealth mode; and
updating the display in response to performing the operation.

2. The method of claim 1, further comprising determining when the operation to be performed on the electronic message is an explicit operation and when the operation is an implicit operation.

3. The method of claim 2, wherein maintaining the state related to the electronic message during interaction with the electronic message while in the stealth mode comprises changing the state related to the electronic message when the operation is the explicit operation.

4. The method of claim 2, wherein the implicit operation is reading the electronic message.

5. The method of claim 2, wherein the explicit operation is at least one of: forwarding the electronic message; moving the electronic message; manually initiating a client defined rule; replying to the electronic message; manually marking the electronic message as being read.

6. The method of claim 5, further comprising maintaining a state of a read property of the electronic message in an unread state after performing the explicit operation.

7. The method of claim 1, further comprising maintaining a display of the electronic messages as displayed before entering the stealth mode during the interaction with the electronic messages during the stealth mode.

8. The method of claim 2, further comprising entering the stealth mode in response to receiving a user selection.

9. The method of claim 1, further comprising displaying an indication showing that the stealth mode is entered.

10. A computer-readable medium having computer-executable instructions for interacting with electronic messages, comprising:
displaying electronic messages;
entering a stealth mode in response to receiving a user interaction;
displaying an indication showing that the stealth mode is entered;
detecting a user interaction requesting an operation to be performed on an electronic message;
performing the operation on the electronic message that attempts to change a state related to the electronic message;
maintaining the state related to the electronic message during interaction with the electronic message while in the stealth mode; and
changing the state related to the electronic message during interaction with the electronic message when outside of the stealth mode.

11. The computer-readable medium of claim 10, further comprising determining when the operation to be performed on the electronic message is an explicit operation and when the operation is an implicit operation.

12. The computer-readable medium of claim 11, wherein maintaining the state related to the electronic message during interaction with the electronic message while in the stealth mode comprises changing the state related to the electronic message when the operation is the explicit operation.

13. The computer-readable medium of claim 11, wherein the implicit operation is at least one of: reading the electronic message; sorting the electronic messages and navigating the messages.

14. The computer-readable medium of claim 11, wherein the explicit operation is at least one of: forwarding the electronic message; moving the electronic message; manually initiating a client defined rule; replying to the electronic message; manually marking the electronic message as being read.

15. The computer-readable medium of claim 14, further comprising maintaining a state of a read property of the electronic message in an unread state after performing the explicit operation and changing an indicator of the electronic message to show the explicit operation as being performed.

16. The computer-readable medium of claim 10, further comprising maintaining a display of the electronic messages as displayed before entering the stealth mode during the interaction with the electronic messages during the stealth mode.

17. A system for interacting with electronic messages, comprising:
a display;
a network connection that is coupled to a network;
a processor and a computer-readable medium;
an operating environment stored on the computer-readable medium and executing on the processor; and
a process operating under the control of the operating environment and operative to perform actions, comprising:
displaying electronic messages;
entering a stealth mode in response to receiving a user interaction;
displaying an indication showing that the stealth mode is entered;
detecting a user interaction requesting an operation to be performed on an electronic message;
performing the operation on the electronic message that attempts to change a state related to the electronic message;
determining when the operation to be performed on the electronic message is an explicit operation and when the operation is an implicit operation;
maintaining the state related to the electronic message during interaction with the electronic message while in the stealth mode and the operation is the implicit operation; and
changing the state related to the electronic message during interaction with the electronic message when outside of the stealth mode or the operation is the explicit operation.

18. The system of claim 17, wherein the implicit operation is reading the electronic message.

19. The system of claim 17, wherein the explicit operation is at least one of: forwarding the electronic message; moving the electronic message; manually initiating a client defined rule; replying to the electronic message; manually marking the electronic message as being read.

20. The system of claim 19, further comprising maintaining a state of a read property of the electronic message in an unread state after performing the explicit operation.
